(19) United States
(12) Patent Application Publication
(10) Pub. No.: US 2010/0310032 A1
(43) Pub. Date: Dec. 9, 2010

(54) METHOD FOR FILLING THE MAIN PRIMARY COOLANT SYSTEM OF A NUCLEAR POWER PLANT WITH WATER AND FOR DRAINING IT OF AIR, AND HEAD FOR IMPLEMENTING THIS METHOD

(75) Inventors: Olivier Demerle, Gien (FR); Francis Mirloup, Ouzouer-Sur-Loire (FR); Frédéric Le Berre, Bollene (FR); Eric Gitton, Ouzouer-Sur-Loire (FR)

Correspondence Address: DRINKER BIDDLE & REATH LLP;ATTN: PATENT DOCKET DEPT., 191 N. WACKER DRIVE, SUITE 3700, CHICAGO, IL, 60606, US

(73) Assignee: ELECTRICITE DE FRANCE, Paris (FR)

(21) Appl. No.: 12/679,153

(22) PCT Filed: Sep. 18, 2008
(86) PCT No.: PCT/FR2008/051673

§ 371 Date: Mar. 19, 2010

(30) Foreign Application Priority Data
Sep. 20, 2007 (FR) 07 06599

(51) Int. Cl. G21C 13/02; G21C 1/09; G21D 1/02

(52) U.S. Cl. 376/205; 376/361; 376/260

(57) ABSTRACT

The invention relates to a method for the water filling and air blow-off of a main primary circuit (1) of a nuclear unit after stopping the same, said main primary circuit (1) including a tank (2) located in a pool of a reactor building (4), primary pumps (5), at least one steam generator (6) including a plurality of steam generating tubes (7) located above the level of the tank (2), and a pressuriser (8).

The present invention relates to a method for filling the main primary coolant system of a nuclear power plant with water and for draining it of air, generally after the power plant has been stopped for refueling, said main primary coolant system comprising a reactor vessel located in a pool of a reactor building, primary coolant pumps, at least one steam generator comprising a plurality of steam generator tubes that are located above the level of the reactor vessel, and a pressurizer.

As is customary, a nuclear power plant is made up of a reactor building, consisting of a concrete containment housing the reactor vessel, said vessel housing the reactor core formed by the fuel assemblies containing the nuclear fuel, together with the main nuclear components of the power plant. The reactor building is thus provided with a main primary coolant system in which water is heated upon contact with the fuel assemblies, is pressurized by a pressurizer, so as to prevent it from boiling, and circulates in this closed coolant system. At least one steam generator is also provided in the primary coolant system so as to receive the hot water circulating in this primary coolant system in hairpin tubes of inverted U shape, thereby enabling the water in a secondary coolant system to be heated and converted into steam.

Each of the power plants of a nuclear power station must be periodically shut down for maintenance and refueling operations.

On certain nuclear sites (generally on the Applicant's sites), the SG hairpin tubes are filled with water by what is called an “evacuation” method, creating the filling by a suction effect explained in detail later. This evacuation method, which is carried out when restarting the nuclear power plant following a shutdown, is not done on most sites in the world, where the hairpin tubes are simply filled with water at the moment the primary coolant pumps are started up. The air thus expelled accumulates in the high points, such as the reactor vessel head, which are then vented. For design reasons, the inverted U tubes are located above the level of the reactor vessel and constitute high points that cannot be vented. The method consisting in expelling the air from the SG hairpin tubes by starting up the primary coolant pumps and then venting after stopping the pumps is commonly called “dynamic venting”.

According to the accident procedures with which certain nuclear sites are equipped in the event of a break in the main primary coolant system, but also for chemical reasons, it is necessary to remove the air contained in the main primary coolant system before starting up the facility. This is the key factor for sites that use instrumentation to measure the water level in the reactor vessel, as this conditions the availability of this measurement system.

To enable the main primary coolant system to be restarted without any air, a method has been implemented for filling the main primary coolant system of a nuclear power plant with water and for draining it of air after said plant has been shut down for refueling. However, when this method is carried out, it is necessary to pass via a step of evacuating the main primary coolant system with nuclear fuel in the reactor vessel. As a result, it is therefore obligatory to comply with a complex operating mode which the nuclear safety rules make expensive in terms of management time and which prolong the shutdown time of the facility.

It is therefore particularly advantageous to carry out a simplified method for filling the main primary coolant system of a nuclear power plant with water and for draining it of air, for the purpose of restarting said plant, while minimizing the costs and complying with the nuclear safety rules.

The present invention therefore relates, according to a first of its aspects, to a method for filling the main primary coolant system of a nuclear power plant with water and for draining it of air after said plant has been shut down for refueling, said main primary coolant system comprising a reactor vessel located in a pool of a reactor building, primary coolant pumps, at least one steam generator comprising a plurality of steam generator tubes that are located above the level of the reactor vessel, and a pressurizer, the method comprising the following steps:
a) the reactor vessel and the pool are filled with water;
b) the reactor vessel is loaded with nuclear fuel;
c) the pool is drained and a head for closing off the reactor vessel is put into position;
d) the water level of the main primary coolant system is adjusted to a low working range in order to bring the volumes of air contained in the tubes, in the pressurizer and in the reactor vessel into communication with one another;
e) the main primary coolant system is evacuated by the suction of vacuum pumps connected to vents on the reactor vessel and on the pressurizer;
f) the main primary coolant system is filled up to a vacuum level and then brought to the atmospheric pressure of the main primary coolant system by opening the vents, by virtue of which the water of the main primary coolant system is drained into the tubes; and
g) the main primary coolant system is filled up to the top of the pressurizer so as to allow the nuclear power plant startup operations to continue,
   the method being characterized in that steps d), e) and f) are carried out before the succession of steps a), b) and c).

Thus, thanks to the method according to the present invention, the tubes are filled with water by evacuation before loading the fuel.

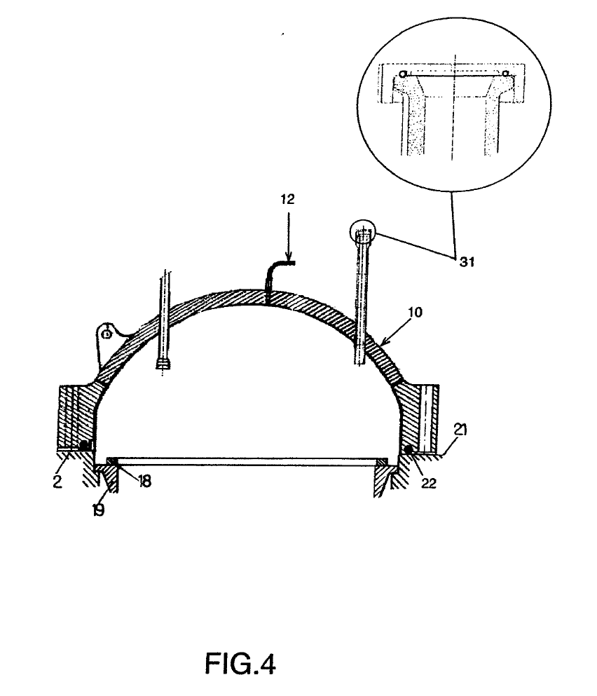

However, even though the method does simplify the procedure for filling the main primary coolant system with water and for draining it of air, it is necessary to maneuver the reactor vessel head, which weighs more than 110 tonnes and which has to be put into position, so as to momentarily seal the main primary coolant system, and then removed at the end of the evacuation step for filling the pool. In order for the reactor vessel head itself to be sealed, a seal is to be placed at the point where it joins the reactor vessel, as will be seen later with reference to FIG. 4 (reference 22), together with blank-offs on the upper penetrations in the head for the core instrumentation outlets (reference 31 in FIG. 4). This method entails an increase in personal dosimetry because of the maneuvering of the head. In addition, it also involves a high labor cost for handling the head, the maneuvering of this head prolonging the shutdown time of the power plant.

According to a first of the aspects of the invention, the reactor vessel head itself may therefore be used, despite its weight, to seal the reactor vessel provided that the appropriate sealing means are employed.

Thus, again to reduce the shutdown time of the power plant and reduce the costs, the method according to the invention includes, before step d), a step of putting a false head into position, closing off the reactor vessel, and a step of sealing this false head at the point where it joins the reactor vessel using sealing means.

It is in fact common practice in nuclear power plants to use a false head, which is put into place on the reactor vessel when it is empty so as to provide biological shielding of the operatives working close to the reactor vessel, to provide dynamic containment of the systems during maintenance operations, to protect the primary coolant system from the ingress of foreign bodies, to allow access for checking the vessel tappings, to clean and examine the vessel mating surface, to decontaminate the reactor pool without introducing clear water into the primary coolant system and to re-cover the upper internals of the reactor vessel during the 10-yearly containment pressure test. Thus, the invention uses as head a false head, which is already in place before implementation of the method and which includes additional sealing means.

Advantageously, the method according to the invention includes, after step f), a step of removing said means for sealing the false head.

Advantageously, provision may be made for the use of a movable flange as means for sealing the false head on the reactor vessel.

According to a second of its aspects, the present invention therefore relates to a false head for implementing the method as described above, characterized in that it includes means for sealing onto the reactor vessel.

According to an advantageous embodiment, the sealing means are a flange.

According to a third of its aspects, the present invention relates to a flange intended for a false head, as described above, characterized in that it includes means for sealing between the false head and the reactor vessel.

Advantageously, the flange includes at least one seal.

The present invention will now be described by means of a purely illustrative and entirely non-limiting example of the scope of the invention, and based on the following illustrations in which:

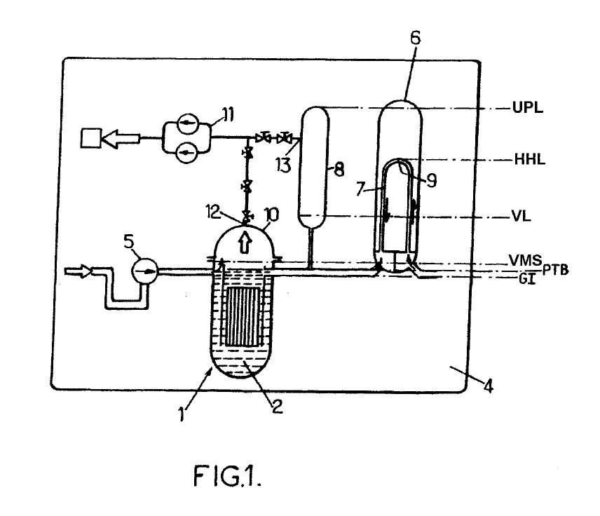

FIG. 1 shows a schematic view of a main primary coolant system of a nuclear power plant;

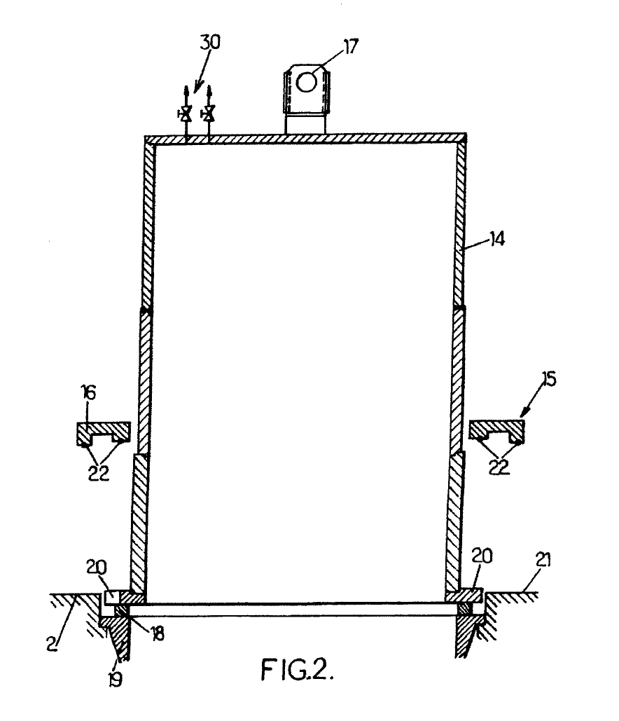

FIG. 2 shows a schematic sectional view of a false head and a movable flange for implementing the method according to the present invention;

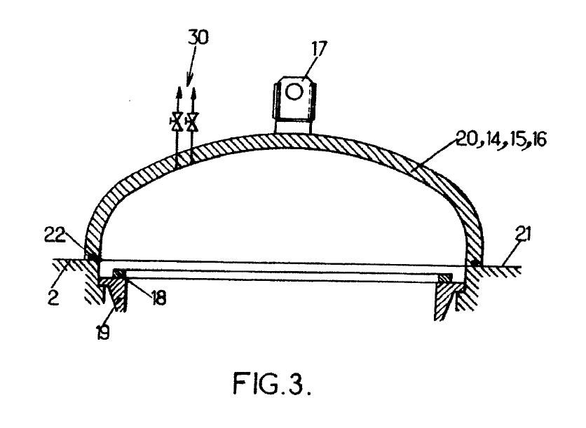

FIG. 3 shows a schematic sectional view of a simpler false head, constituting a fixed flange, as a variant of FIG. 2; and

FIG. 4 shows a conventional reactor vessel head, but one equipped with suitable sealing means for implementing the method.

FIG. 1 therefore shows a schematic view of the main primary coolant system 1 of a nuclear power plant comprising a reactor vessel 2 located in a pool (not shown in the figures, but of a type known per se) of a reactor building 4, and primary coolant pumps 5 capable of circulating the water in the main primary coolant system 1.

The system 1 also includes at least one steam generator comprising a plurality of steam generator tubes 7 located above the level of the reactor vessel 2, and a pressurizer 8. The tubes 7 have a general inverted U shape, each with a high point 9 (which corresponds to the High Level of the Hairpin of this tube 7 located at the HHL (hairpin high level) in FIG. 1), which cannot easily be vented.

As is customary, to fill the main primary coolant system with water and to drain it of air, the following steps are carried out:
a) the reactor vessel 2 and the pool are filled with water. Advantageously, the reactor vessel 2 serves during this step as means for filling the pool at the bottom of which said vessel is located. The air contained within the tubes 7 partially filled with water is then compressed in the hairpin parts 9 of the tubes 7;
b) the reactor vessel 2 is loaded with nuclear fuel;
c) the pool is drained and a head 10 for closing off the reactor vessel 2 is put into position. The water is then level with the vessel mating surface with the reference VMS in FIG. 1;
d) the water level of the main primary coolant system is adjusted to a low working range (with the reference LWR in FIG. 1) so as to bring the air volumes contained in the tubes 7, in the pressurizer 8 and in the reactor vessel 2 into communication with one another;
e) the main primary coolant system is evacuated by the suction of vacuum pumps 11 that are connected to vents 12, 13 on the reactor vessel 2 and on the pressurizer 8. This step creates a partial vacuum of 800 mbar relative to the outside of the system which is at atmospheric pressure;
f) the main primary coolant system is filled up to a vacuum level (with the reference VL in FIG. 1) and then the main primary coolant system is brought to atmospheric pressure by opening the vents 12, 13, by virtue of which the water in the main primary coolant system is drawn into the tubes 7; and
g) the main primary coolant system 1 is filled up to the top of the pressurizer 8 so as to allow the nuclear power plant startup operations to continue.

According to the invention, steps d), e) and f) are carried out before the succession of steps a), b) and c).

Thus, during step a), the amount of air in the tubes is considerably less because the tubes 7 have already been filled during steps d), e) and f). Thus, according to the invention, steps d), e), f), a), b), c) and g) are carried out in succession.

However, using this method it is necessary, before step d), to put the reactor vessel head 10, provided with the seal 22 and with the blank-offs 31, into position so as to momentarily seal the main primary coolant system 1 and then, at the end of the evacuation step for filling the pool, to remove said head before subsequently putting it back into position in step c). The head 10 therefore has to be manipulated twice, something which should be avoided as this head 10, weighing more than 110 tonnes is difficult to maneuver and the activity is time-consuming.

Thus, according to another aspect of the invention, it is proposed to use a false head 14 which is put into place on the reactor vessel 2 with sealing means 15, which thus seal the reactor vessel 2 on which said head is placed.

The false head 14 is a component used as the head of a nuclear reactor vessel 2 when the power plant is in shutdown mode. It has a lining or is made of a decontaminable material.

As is common practice, a false head 14 is used to provide a biological shield for operatives working close to the pool, to place the main primary coolant system under a dynamic vacuum during the maintenance operations, to protect the primary coolant system from the ingress of foreign bodies, to use the machine for checking the vessel tappings (said machine being of the type known per se) with the false head 14 in place, to clean and examine the vessel mating surface (or VMS), to decontaminate the reactor pool, optionally to recover the upper internals of the reactor vessel during the 10-yearly containment pressure test, optionally to access the irradiation plugs and not damage the nozzle tubes upon positioning the false head.

Thus, the method according to the invention therefore includes, before step d), a step of putting a false head 14, closing off the reactor vessel 2, into position and a step of sealing this false head 14 at the point where it joins the reactor vessel 2 using sealing means 15 and, after step f), a step of removing the false head 14.

Preferably, provision is made for a flange 16 (which is movable (FIG. 2) or fixed (FIG. 3)) to be used as sealing means 15 for sealing the false head 14 on the reactor vessel 2.

By adding a step of sealing the false head 14, any step of handling a head, during the process according to the invention of filling with water and draining of air is thus avoided.

FIG. 2 shows a schematic sectional view of a false head 14 on which the movable flange 16 according to the invention is intended to be sealingly fastened.

This figure thus shows a false head 14 that includes a lifting ring 17. The false head 14 rests on a hold-down ring 18 placed on the periphery of the reactor core barrel 19 located by design inside the reactor vessel 2.

The flange 16 according to the invention may either be directly incorporated into the false head 14 or may be designed to be removable therefrom (as shown in FIG. 2). In both cases, the flange 16 must provide the required sealing between the ledge 20 of the false head 14 and the vessel mating surface (or VMS) i.e. the upper surface 21 of the reactor vessel 2.

Preferably, if the sealing flange 16 is movable it is maneuvered, for coming into contact with the reactor vessel 2, by an integrated device without external handling means (such as a crane), said maneuvering being easy so as to minimize the time during which the personnel are working and exposed to the radiation. In addition, the retention of this movable flange 16 in the high position guarantees that there is no risk of it dropping, avoiding any risk of a personal accident or damage to the vessel mating surface 21.

The total weight of the combination of storage box and false head 14 must remain compatible with the lifting means that are available on the site. On sites where it is used, the false head 14 is considerably lighter than the head 10, making it easier to handle than the usual head 10, weighing more than 110 tonnes, of the reactor vessel 2.

In general, the false head 14 must be sealed perfectly so as to allow the method according to the invention to be carried out.

A stainless steel skin coated on all the parts of the false head 14 in contact with the equipment of the primary coolant system 1 is also provided.

The false head 14 is advantageously designed to be able to withstand filling with borated water up to the level VL when it is under a partial vacuum of 800 mbar relative to atmospheric pressure. For this purpose there must be no risk of boric acid corroding the wetted part of the false head 14.

Advantageously, the false head 14 is fitted with two additional flanges in the upper portion, so as to connect the vacuum hose (for the suction by the vacuum pumps 11) and for connecting the tubing for measuring the water level in the reactor vessel 2 using a hose. The height of these connections is above the level VL on the false head 14. The sealing system is designed so as to maintain the sealing function should the height of the false head vary under the influence of the external atmospheric pressure exerted thereon for a vertical movement of a few millimeters because of the flexibility of the hold-down ring 18.

The flange 16 must be put into position, for example by simple contact, on the reactor vessel 2 before the step of reducing the pressure in the tubes 7 by suction, which will press the flange 16 onto the vessel 2 and the false head 14.

The shape of the flange 16 advantageously follows the profile of the reactor vessel 2 and that of the false head 14 at the point where they are joined. For example, one portion of the flange 16 bears on the ledge 20 of the false head 14 whereas another portion of the flange 16 bears on the upper surface 21 of the vessel 2.

Any means for keeping the flange 16 fastened to the false head 14 and the reactor vessel 2 is advantageously used (if said flange is movable), for example, by clip-fastening or screwing means, so that the flange 16 is not raised by a vertical thrust or by a malfunction during the operation.

Physical sealing is provided by one or more seals 22 placed on the shaped parts provided on the flange 16. The seals 22 used may be based on a polymer, graphite, natural fiber in solid form (such as braids for glands, sheets, papers, fibrous materials for flat gaskets ready to be used or for being cut, O-ring seals or lipped seals) or in pasty or liquid form (sealing paste, mastics and liquid seals).

Moreover, because the flange 16 must not deactivate the primary functions of the false head 14, the flange 16 is designed to move so as to be able to be raised to a minimum height enabling, in this position, the tools normally employed to be used close to the vessel mating surface (VMS), for example so as to allow passage of a machine for inspecting the vessel tappings, this machine being of a type known per se. As an example of the size of the machine for inspecting the vessel tappings, this has a height of 1100 mm and has lateral wheels that bear on the vessel mating surface over a width of 52 mm.

Also shown in FIG. 2 are connection tap-offs 30 for level measurements and for the vacuum hose.

The embodiment shown in FIG. 2 then refers to a construction in which the flange is advantageously movable. However, in an alternative embodiment shown in FIG. 3 the flange may be fixed, as illustrated at the reference 22 in this FIG. 3. The similar elements in FIGS. 2 and 3 bear the same references. The use of such equipment illustrated in FIG. 3 does not, however, fulfill all the functions of the equipment described in FIG. 2 (in particular that of recovering the upper internals of the reactor vessel during the shutdown).

Thus, the invention consists, according to one of its aspects, in adding to the functions of the false head 14 of a type known per se, the possibility of reducing the pressure in the main primary coolant system 1 to 800 mbar relative to the outside (which is at atmospheric pressure), thereby requiring sealing means to be installed. Additionally, the invention also provides for additional connections for the vacuum hose and for measuring the water level in the reactor vessel.

The present invention makes it possible to raise the operating safety level by dispensing with the transient stage with a low water level in the main primary coolant system 1 while there is fuel in the reactor vessel 2. It also makes it possible to dispense with the “dynamic venting” operating when this is planned, this being a longer operation than that of implementing the method and therefore shortens the time during which the facility is shut down.

Although advantageous, the use of a false head remains optional. This is because the true head may be positioned directly on the reactor vessel, as illustrated in FIG. 4, so as to carry out the method according to the invention. Thus, the general method according to the invention may be carried out with the true head or else with a false head as described above. In the case of the true head being employed, the seal 22, for example of the elastomer type, is placed in the groove of the head. Simple blank-offs 31 are preferably used to seal the upper core instrumentation outlet penetrations through the head, as illustrated in FIG. 4.

1-8. (canceled)

9. A method for filling the main primary coolant system of a nuclear power plant with water and for draining it of air after said plant has been shut down, said main primary coolant system comprising:
a reactor vessel located in a pool of a reactor building,
primary coolant pumps,
at least one steam generator comprising a plurality of steam generator tubes located above the level of the reactor vessel, and
a pressurizer,
the method comprising the following steps:
a) filling the reactor vessel and the pool with water;
b) loading the reactor vessel with nuclear fuel;
c) draining the pool and positioning a head for closing off the reactor vessel;
d) adjusting the water level of the main primary coolant system to a low working range in order to bring the volumes of air contained in the tubes, in the pressurizer and in the reactor vessel into communication with one another;
e) evacuating the main primary coolant system by the suction of vacuum pumps connected to vents on the reactor vessel and on the pressurizer;
f) filling the main primary coolant system to a vacuum level and then brought to the atmospheric pressure of the main primary coolant system by opening the vents, by virtue of which the water of the main primary coolant system is drained into the tubes; and
g) filling the main primary coolant system to the top of the pressurizer so as to allow the nuclear power plant startup operations to continue,
wherein steps d), e) and f) are carried out before the succession of steps a), b) and c).

10. The method as claimed in claim 9, wherein it is provided:
before step d), a positioning of a false head, closing off the reactor vessel, and
a step of sealing said false head at the point where it joins the reactor vessel using sealing means.

11. The method as claimed in claim 9, further comprising, after step f), a step of removing the false head.

12. The method as claimed in claim 10, wherein it is provided a flange to be used as means for sealing the false head onto the reactor vessel.

13. The method as claimed in claim 11, wherein it is provided a flange to be used as means for sealing the false head onto the reactor vessel.

14. A false head for implementing the method as claimed in claim 10, wherein it includes means for sealing onto the reactor vessel.

15. A false head for implementing the method as claimed in claim 11, wherein it includes means for sealing onto the reactor vessel.

16. A false head for implementing the method as claimed in claim 12, wherein it includes means for sealing onto the reactor vessel.

17. A false head for implementing the method as claimed in claim 13, wherein it includes means for sealing onto the reactor vessel.

18. The head as claimed in claim 14, wherein the sealing means are a flange.

19. A flange intended for a false head as claimed in claim 15, wherein said flange has means for sealing between the false head and the reactor vessel.

20. The flange as claimed in claim 19, wherein it includes at least one seal.
